(19) United States
(12) Patent Application Publication
(10) Pub. No.: US 2005/0158606 A1
(43) Pub. Date: Jul. 21, 2005

(54) Mounting frame for fuel cell stack

(75) Inventors: Jianwei Xia, Shanghai (CN); Weiliang Guo, Shanghai (CN)

Correspondence Address: Raymond Y. Chan, 108 N. Ynez Ave., #128, Monterey Park, CA, 91754, US

(73) Assignee: Shen-Li High Tech Co., Ltd. (Shanghai), Shanghai (CN)

(21) Appl. No.: 11/036,300

(22) Filed: Jan. 14, 2005

(30) Foreign Application Priority Data
Jan. 16, 2004 (CN) 2004100158882

(51) Int. Cl. H01M 2/10; A47G 29/00

(52) U.S. Cl. 429/34; 429/96; 211/71.01

(57) ABSTRACT

A mounting frame includes a cell enclosure and a retention arrangement. The cell enclosure comprises a first boundary frame including four first boundary legs and a second boundary frame including four second boundary legs extending to align with the four first boundary legs respectively to form a box-shaped structure for fittingly framing a fuel cell stack. The retention arrangement includes four pairs of first and second coupling members provided at free ends of the four first boundary legs and the four boundary legs respectively, and four affixing elements arranged when the four first boundary legs are aligned with the second boundary legs to overlap the first and second coupling members, the affixing element is detachably connected the first and second coupling members so as to securely lock up the first boundary frame with the second boundary frame for retaining the fuel cell stack therewithin.

### BACKGROUND OF THE PRESENT INVENTION

1. Field of Invention

The present invention relates to an auxiliary device for fuel cell, and more particularly, relates to a mounting frame for fuel cell stack.

2. Description of Related Arts

Electrochemical fuel cell is a kind of electrochemical energy conversion device which is capable of converting the hydrogen and oxidant into electrical energy. The core part of such fuel cell is a membrane electrode assembly, which is shortened as (MEA). The MEA comprises a proton exchange membrane sandwiched by two layers of porous sheets made of conductive material, such as carbon tissue. Furthermore, catalyst like metal platinum powder, adapted for facilitating the electrochemical reaction, are evenly and granularly provided on two layers of carbon tissue to form two catalytic interfaces between MEA and carbon tissue. Finally, electrically conductible members are provided on two sides of MEA to form a cathode side and an anode side, in such a manner, electron generated from the electrochemical reaction could be lead out through an electrical circuit.

The anode side of the MEA is supplied with fuel, such as hydrogen, for initiating an electrochemical reaction. The fuel is directed through the porous and diffused carbon tissue so as to be deionized on the catalytic interface for the loss of electrons to generate positive ions. Moreover, such positive ions are capable of transferably permeating the proton exchange membrane to reach the cathode side. On the other hand, oxidant-containing gas, such as air, is supplied to the cathode side of the MEA. Accordingly, the oxidant-containing gas is able to permeate the porous and diffused carbon tissue to be ionized for the addition of the electrons to generate negative ions. As a result, the positive ions transferred from the anode side will meet the negative ions to generate electrochemical reaction.

In case of the hydrogen is used as fuel and the oxygen containing air is employed as the oxidant, the electrochemical reaction on the anode side generates hydrogen positive ions (protons). The proton exchange membrane is capable of facilitating the hydrogen positive ions migrate from the anode side to the cathode side. In addition, the proton exchange member has another function as a separator for blocking hydrogen from being directly contacted with the oxygen containing air so as to prevent the mixture of hydrogen and oxygen as well as the explosive reaction.

The electrochemical reaction on the cathode side generates negative ions by obtaining the electrons. As a result, the negative ions generated on the cathode side will attract the positive ions transferred from the anode side to form water molecule as reaction product. In the electrochemical fuel cells which utilized the hydrogen as the fuel and oxygen containing air as oxidant, the electrochemical reaction is expressed by the following formula:
Anode: H₂→2H⁺+2e
Cathode: ½O₂+2H⁺+2e→H₂O

In the typical proton exchanging membrane fuel cell system, the MEA is disposed between two electrically conductible electrode plates, wherein the contacting interface of each electrode plate at least defines one flowing channel. The flowing channel could be embodied by conventional mechanical method such as pressure casting, punching, and mechanical milling. The electrode plate could be embodied as metal electrode plate or graphite electrode plate. So the flowing channels defined on the electrode plate are capable of directing fuel and oxidant into anode side and cathode side respectively positioned on opposite side of the MEA. Within the art, such electrode plate is called flow field plate. For a single fuel cell structure, only one MEA is provided and disposed between an anode flow field plate and a cathode flow field plate. Here, the flow field plates are not only embodied as current-collecting device, but also functioned as supporting device for securely holding the MEA there between. The flowing channels defined on the flow field plate are capable of delivering fuel and oxidant to the catalytic interfaces of the anode side and cathode side, and removing the water discharged from the electrochemical reaction of fuel cell.

To increase the overall power output of the proton exchanging membrane fuel cell, two or more fuel cell units are electrically connected in series with a stacked manner or a successive manner to form a fuel cell stack. In such stacked series manner, each flow field plate comprises flowing channels defined on opposite side of plate respectively, wherein one side of the flow field plate is applied as an anode flow field plate contacting with the anode interface of a MEA, while another side of the flow field plate is applied as a cathode flow field plate contacting with the cathode interface of an adjacent MEA.

That is to say, one side of such flow field plate serves as an anode flow field plate for one fuel cell unit and the other side of flow field plate serves as a cathode flow field plate for the adjacent fuel cell unit. Within the art, this kind of structure is called bipolar plate. Conclusively, a fuel cell stack comprises a plurality of fuel cell units electrically connected in a successive manner, a front end plate and rear end plate disposed at two end of such fuel cell stack, and a fastening member for exerting a compressive force so as to sandwiching the plurality of fuel cell units between two end plates.

A typical fuel cell comprises a first manifold having a first inlet and a first outlet adapted for evenly dispersing fuel, such as hydrogen, methanol, alcohol, natural gas, and hydrogen rich gas reformed from gasoline into flowing channels defined on the anode flow field plates; a second manifold which has a second inlet and a second outlet adapted for evenly dispersing oxidant, such as oxygen and air, into the flowing channels defined on the cathode flow field plates; a third manifold which has a third inlet and a third outlet adapted for delivering coolant like water through the fuel cell stack for absorbing the heat generated from the electrochemical reaction of the fuel cell stack for a radiation purpose. It is noted that the first outlet and second outlet are also adapted for leading out the water generated from the electrochemical reaction. Commonly, all above mentioned manifold inlets and outlets are defined on an end plate or two opposite end plates.

It has been practiced in the art to use such fuel cell stack as power unit for propelling vehicles including four-wheeled motor vehicles, motorcycles, and vessels, and for operating other electrically operated machines such as portable generators.

Commonly, a fuel cell generating system comprises a fuel cell stack and a supporting arrangement for holding the fuel cell stack. So that when the fuel cell generating system is utilized as a power system to drive a vehicle or a ship, the fuel cell generating system could be directly embodied as a fuel cell engine. Sometimes, the fuel cell generating system could be applied as a portable or a fixed generator.

That is to say, in routine applications, the fuel cell stack as well as its supporting system must be assembled, packaged and securely fixed to be embodied as fuel cell engine or generator. This is due to the fact that only packaged and fixed fuel cell stack would be dustproof, shockproof, waterproof, leakage preventative, and esthetically appealing for satisfying the requirements as engine or generator.

As shown in FIG. 1, a conventional fuel cell stack comprises a pair of end plates, namely, a front end plate and a rear end plate, respectively provided on two ends of the fuel cell stack. For secure reasons, at least two retention bars are provided for securely holding together the front end plate and the rear end plate. By adjusting and fastening the retention bars, the user is able to tightly sandwich the fuel cell stack between the front end plate and the rear end plate.

In present, the packaging and fixing procedure of such fuel cell stack is relatively simple to follow. As shown in FIG. 2, a conventional method for packaging a fuel cell stack includes the following steps:
(1) providing four planar panels to form a rectangle body for receiving a fuel cell stack, afterwards, providing a pair of end plates, respectively a front end plate and a rear end plate, disposed at two ends of the rectangle body, wherein the front end plate and the rear end plate are aligned with four planar panels, so that end plates could be securely screwed on four planar panels;
(2) providing four packaging strips at four lateral edges, wherein two ends of the packaging strip are extended beyond the rectangle body to form a projected neck having fixing holes defined thereon; and
(3) fastening the four packaging strips onto the rectangle body, so that by inserting a plurality of screws into the fixing holes of projected neck, the fuel cell stack is capable of being mounted to surrounding structure.

In case a fuel cell generating system is utilized for supporting vehicles, vessels, the minimum requirement of such fuel cell system could be tens or even hundreds of thousand watts. Therefore, the fuel cell stack should be sizeable for maintaining the generating operation.

However, it is impossible to assemble a fuel cell stack comprising a plurality of sized electrode flow field plate to output such a powerful energy. Instead, a plurality of middle sized fuel cell stacks could be congregated or assembled to provide a powerful output.

Unfortunately, such congregated, powerful fuel cell stacks could not be packaged or securely fixed according to the conventional packaging method as shown in FIG. 2. This is due to the fact that such powerful fuel cell stack are so bulky and sizable, the conventional packaging and fixing procedure are no more suitable to support such congregated fuel cell stack.

Furthermore, it is highly required that a packaged fuel cell stack should be embodied as shockproof, the conventional packaging procedure could not satisfy such requirement.

### SUMMARY OF THE PRESENT INVENTION

A primary object of the present invention is to provide a mounting device for congregated fuel cell stack, wherein the mounting frame is easy to maintain, convenient to assemble and disassemble, shockproof, and structurally secure so as to overcome aforementioned drawbacks of conventional packaging procedure.

Accordingly, to achieve the above mentioned object, the present invention provides a mounting frame for a fuel cell stack having end plates, comprising a cell enclosure, a retention arrangement, and a locking arrangement.

The cell enclosure comprises a first boundary frame comprising four first boundary legs and a second boundary frame comprising four second boundary legs extending to align with the four first boundary legs respectively to form a box-shaped structure for fittingly framing edges of the fuel cell stack within the first and second boundary frames.

The retention arrangement comprises four pairs of first and second coupling members, each of which has a retention hole, provided at free ends of the four first boundary legs and the four boundary legs respectively, and four affixing elements arranged in such a manner that when the four first boundary legs are aligned with the second boundary legs to overlap the corresponding first and second coupling members that the retention holes thereof are aligned with each other, the affixing element is detachably connected the first and second coupling members through the retention holes thereof so as to securely lock up the first boundary frame with the second boundary frame for retaining the fuel cell stack therewithin.

The locking arrangement comprises at least four locking units outwardly extended from the cell enclosure for locking up the cell enclosure with an external fixture so as to securely retain the fuel cell stack in position.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a conventional fuel cell stack.

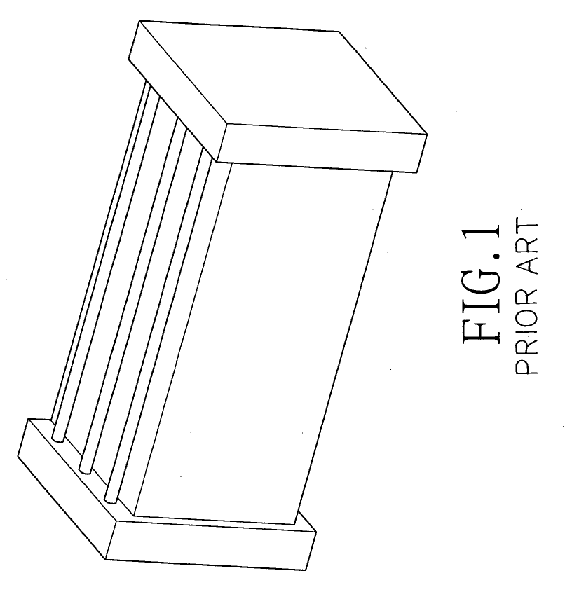

FIG. 2 is a schematic view of a conventional mounting container for the fuel cell stack.

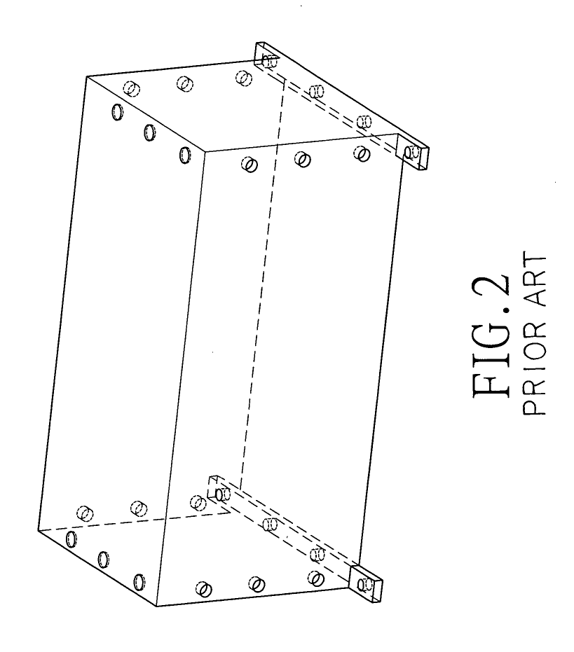

FIG. 3 is a schematic view of a mounting frame for a fuel cell stack according to the preferred embodiment of the present invention.

FIG. 4 illustrates a first alternative mode of the mounting frame for the fuel cell stack according to the preferred embodiment of the present invention.

FIG. 5 illustrates a second alternative mode of the mounting frame for the fuel cell stack according to the preferred embodiment of the present invention.

FIG. 6 illustrates a third alternative mode of the mounting frame for the fuel cell stack according to the preferred embodiment of the present invention.

FIG. 7 is a schematic view showing a fuel cell stack is received within the mounting frame according to the preferred embodiment of the present invention.

### DETAILED DESCRIPTION OF THE PREFERRED EMBODIMENT

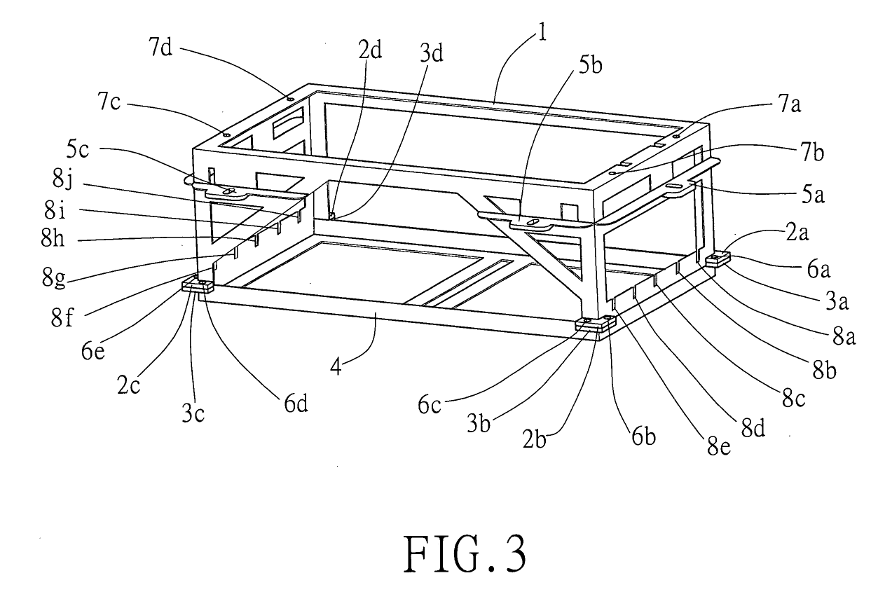

Referring to the FIGS. 3 to 7, the mounting frame for a congregated fuel cell stack according to the preferred embodiment of the present invention is illustrated, wherein the fuel cell stack generally comprises a plurality of fuel cell units, a pair of end plates sandwiching the fuel cell units, and reinforcing arm extended between the end plates to securely the fuel cell units therebetween. The mounting frame comprises a cell enclosure, a retention arrangement, and a locking arrangement.

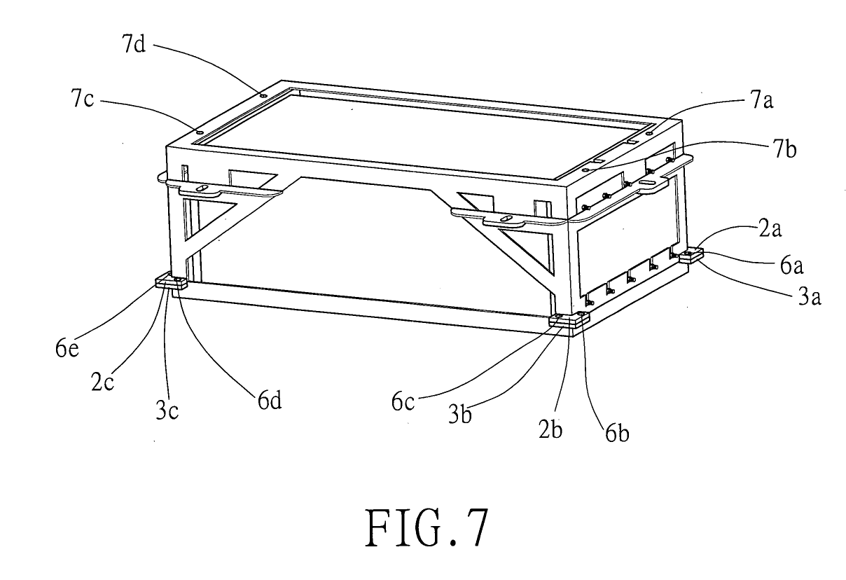

The cell enclosure comprises a first boundary frame 1 comprising four first boundary legs and a second boundary frame 4 comprising four second boundary legs extending to align with the four first boundary legs respectively to form a box-shaped structure for fittingly framing edges of the fuel cell stack within the first and second boundary frames 1, 4. The retention arrangement comprises four pairs of first and second coupling members 2a˜2d, 3a˜3d, each of which has a retention hole 6a˜6e . . . , provided at free ends of the four first boundary legs and the four second boundary legs of the first and second boundary frames 1, 4 respectively, and four affixing elements arranged in such a manner that when the four first boundary legs are aligned with the second boundary legs to overlap the corresponding first and second coupling members 2a˜2d, 3a˜3d that the retention holes 6a˜6e . . . thereof are aligned with each other, the affixing element is detachably connected the first and second coupling members 2a˜2d, 3a˜3d through the retention holes 6a˜6e . . . thereof so as to securely lock up the first boundary frame 1 with the second boundary frame 4 for retaining the fuel cell stack therewithin. Therefore, the fuel cell stack can be easily attached to or detached from the cell enclosure via the retention arrangement. Accordingly, wherein the first and second boundary frames 1, 4 are upper and lower boundary frames for fittingly mounting at upper and lower portions of the fuel cell stack respectively, wherein a length of each of the first boundary legs is shorter than a length of each of the second boundary legs. Alternatively, the first coupling members are extended from the first boundary frame 1 as the first boundary legs to couple with the second boundary legs of the second boundary frame 4 respectively. Each of the locking units comprises a locking member 5a˜5d, having a locking slot 9a˜9d, outwardly extended from the respective first boundary leg for overlapping with the external fixture at a position that the locking slot 9a˜9d is aligned with an affixing hole of the external fixture, and a detachably locker securely locking the locking member on the external fixture through the locking slot so as to securely lock up the cell enclosure with the external fixture. The present invention further provides two structures for conveniently and detachably mounting the fuel cell stack to the mounting frame. The retention arrangement further has a plurality of screw holes 7a˜7d spacedly formed on the first boundary frame 1 for aligning with holes on each of the end plates of the fuel cell stack, wherein a plurality of screws are detachably mounted on the first boundary frame 1 at the screw holes 7a˜7d for securely locking the first boundary frame 1 with the fuel cell stack so as to securely mount the fuel cell stack within the first and second boundary frames 1, 4 in position. The retention arrangement further has a plurality of screw slots 8a˜8o spacedly formed on the second boundary frame 4 for aligning with apertures of the fuel cell stack, wherein a plurality of screws 8a˜8o are detachably mounted on the second boundary frame 4 at the screw slots for securely locking the second boundary frame 4 with the fuel cell stack so as to securely mount the fuel cell stack within the first and second boundary frames 1, 4 in position, as shown in FIG. 7.

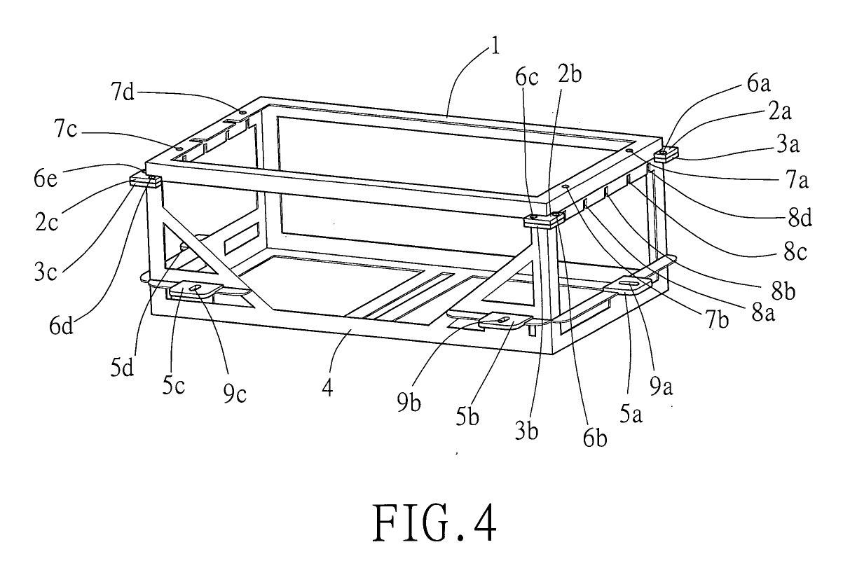

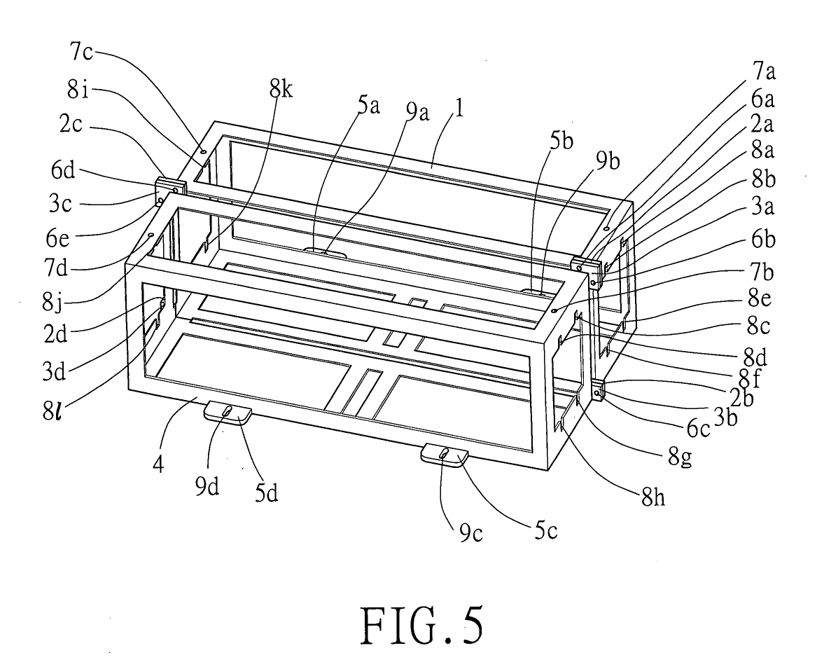

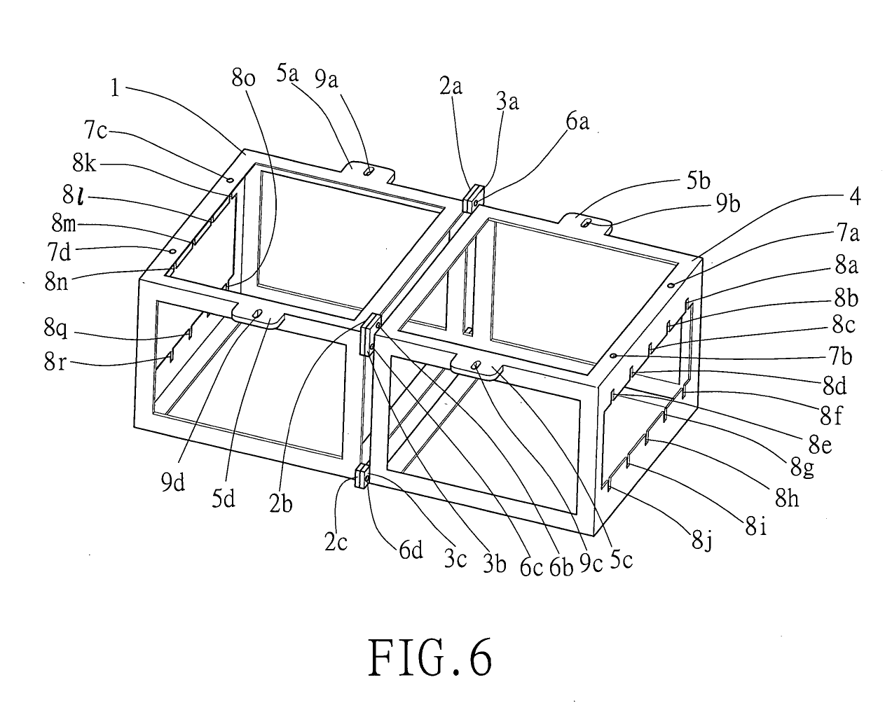

As shown in FIGS. 5 and 6, the alternative mode of the mounting frame of the present invention are illustrated. The first and second boundary frames 1, 4 are front and rear boundary frames respectively, wherein a length of each of the first boundary legs is equal to a length of each of the second boundary legs. Alternative, the first and second boundary frames 1, 4 are left and right boundary frames respectively, wherein a length of each of the first boundary legs is equal to a length of each of the second boundary legs. The detachably mounting operation of the mounting frame is the same as shown in FIGS. 3 and 4.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A mounting frame for a fuel cell stack having two end plates, comprising:
a cell enclosure comprising a first boundary frame comprising four first boundary legs and a second boundary frame comprising four second boundary legs extending to align with said four first boundary legs respectively to form a box-shaped structure for fittingly framing edges of said fuel cell stack within said first and second boundary frames;
a retention arrangement comprising four pairs of first and second coupling members, each of which has a retention hole, provided at free ends of said four first boundary legs and said four boundary legs respectively, and four affixing elements arranged in such a manner that when said four first boundary legs are aligned with said second boundary legs to overlap said corresponding first and second coupling members that said retention holes thereof are aligned with each other, said affixing element is detachably connected said first and second coupling members through said retention holes thereof so as to securely lock up said first boundary frame with said second boundary frame for retaining said fuel cell stack therewithin; and
a locking arrangement comprises at least four locking units outwardly extended from said cell enclosure for locking up said cell enclosure with an external fixture so as to securely retain said fuel cell stack in position.

2. The mounting frame, as recited in claim 1, wherein each of said locking units comprises a locking member, having a locking slot, outwardly extended from said respective first boundary leg for overlapping with said external fixture at a position that said locking slot is aligned with an affixing hole of said external fixture, and a detachably locker securely locking said locking member on said external fixture through said locking slot so as to securely lock up said cell enclosure with said external fixture.

3. The mounting frame, as recited in claim 1, wherein said retention arrangement further has a plurality of screw holes spacedly formed on said first boundary frame for aligning with holes on each of said end plates of said fuel cell stack, wherein a plurality of screws are detachably mounted on said first boundary frame at said screw holes for securely locking said first boundary frame with said fuel cell stack so as to securely mount said fuel cell stack within said first and second boundary frames in position.

4. The mounting frame, as recited in claim 2, wherein said retention arrangement further has a plurality of screw holes spacedly formed on said first boundary frame for aligning with holes on each of said end plates of said fuel cell stack, wherein a plurality of screws are detachably mounted on said first boundary frame at said screw holes for securely locking said first boundary frame with said fuel cell stack so as to securely mount said fuel cell stack within said first and second boundary frames in position.

5. The mounting frame, as recited in claim 1, wherein said retention arrangement further has a plurality of screw slots spacedly formed on said second boundary frame for aligning with apertures of said fuel cell stack, wherein a plurality of screws are detachably mounted on said second boundary frame at said screw slots for securely locking said second boundary frame with said fuel cell stack so as to securely mount said fuel cell stack within said first and second boundary frames in position.

6. The mounting frame, as recited in claim 2, wherein said retention arrangement further has a plurality of screw slots spacedly formed on said second boundary frame for aligning with apertures of said fuel cell stack, wherein a plurality of screws are detachably mounted on said second boundary frame at said screw slots for securely locking said second boundary frame with said fuel cell stack so as to securely mount said fuel cell stack within said first and second boundary frames in position.

7. The mounting frame, as recited in claim 3, wherein said retention arrangement further has a plurality of screw slots spacedly formed on said second boundary frame for aligning with apertures of said fuel cell stack, wherein a plurality of said screws are detachably mounted on said second boundary frame at said screw slots for securely locking said second boundary frame with said fuel cell stack so as to securely mount said fuel cell stack within said first and second boundary frames in position.

8. The mounting frame, as recited in claim 4, wherein said retention arrangement further has a plurality of screw slots spacedly formed on said second boundary frame for aligning with apertures of said fuel cell stack, wherein a plurality of said screws are detachably mounted on said second boundary frame at said screw slots for securely locking said second boundary frame with said fuel cell stack so as to securely mount said fuel cell stack within said first and second boundary frames in position.

9. The mounting frame, as recited in claim 1, wherein said first and second boundary frames are upper and lower boundary frames for fittingly mounting at upper and lower portions of said fuel cell stack respectively, wherein a length of each of said first boundary legs is shorter than a length of each of said second boundary legs.

10. The mounting frame, as recited in claim 4, wherein said first and second boundary frames are upper and lower boundary frames for fittingly mounting at upper and lower portions of said fuel cell stack respectively, wherein a length of each of said first boundary legs is shorter than a length of each of said second boundary legs.

11. The mounting frame, as recited in claim 8, wherein said first and second boundary frames are upper and lower boundary frames for fittingly mounting at upper and lower portions of said fuel cell stack respectively, wherein a length of each of said first boundary legs is shorter than a length of each of said second boundary legs.

12. The mounting frame, as recited in claim 1, wherein said first and second boundary frames are upper and lower boundary frames for fittingly mounting at upper and lower portions of said fuel cell stack respectively, wherein said first coupling members are extended from said first boundary frame as said first boundary legs to couple with said second boundary legs of said second boundary frame respectively.

13. The mounting frame, as recited in claim 4, wherein said first and second boundary frames are upper and lower boundary frames for fittingly mounting at upper and lower portions of said fuel cell stack respectively, wherein said first coupling members are extended from said first boundary frame as said first boundary legs to couple with said second boundary legs of said second boundary frame respectively.

14. The mounting frame, as recited in claim 8, wherein said first and second boundary frames are upper and lower boundary frames for fittingly mounting at upper and lower portions of said fuel cell stack respectively, wherein said first coupling members are extended from said first boundary frame as said first boundary legs to couple with said second boundary legs of said second boundary frame respectively.

15. The mounting frame, as recited in claim 1, wherein said first and second boundary frames are front and rear boundary frames respectively, wherein a length of each of said first boundary legs is equal to a length of each of said second boundary legs.

16. The mounting frame, as recited in claim 4, wherein said first and second boundary frames are front and rear boundary frames respectively, wherein a length of each of said first boundary legs is equal to a length of each of said second boundary legs.

17. The mounting frame, as recited in claim 8, wherein said first and second boundary frames are front and rear boundary frames respectively, wherein a length of each of said first boundary legs is equal to a length of each of said second boundary legs.

18. The mounting frame, as recited in claim 1, wherein said first and second boundary frames are left and right boundary frames respectively, wherein a length of each of said first boundary legs is equal to a length of each of said second boundary legs.

19. The mounting frame, as recited in claim 4, wherein said first and second boundary frames are left and right boundary frames respectively, wherein a length of each of said first boundary legs is equal to a length of each of said second boundary legs.

20. The mounting frame, as recited in claim 8, wherein said first and second boundary frames are left and right boundary frames respectively, wherein a length of each of said first boundary legs is equal to a length of each of said second boundary legs.
